(19) United States
(12) Patent Application Publication
(10) Pub. No.: US 2004/0146299 A1
(43) Pub. Date: Jul. 29, 2004

(54) Periodic optical packet switching

(76) Inventor: George Clapp, Naperville, IL (US)

Correspondence Address: TELCORDIA TECHNOLOGIES, INC., ONE TELCORDIA DRIVE 5G116, PISCATAWAY, NJ, 08854-4157, US

(21) Appl. No.: 10/353,526

(22) Filed: Jan. 29, 2003

(51) Int. Cl. H04J 14/02; H04J 14/00

(52) U.S. Cl. 398/49; 398/54

(57) ABSTRACT

In an optical network, data is sent from a source to a destination over a plurality of wavelengths of light transmitted over optical fibers and switched at a number of optical packet switches. In periodic optical packet switching (POPS), a network management system divides each wavelength into time-slots. In response to a request from a source to transmit variable length data packets to a destination, the network management system allocates an inter-packet interval for the connection. The inter-packet interval is the number of time slots allocated for transmission of a data packet. The source may only begin transmitting a data packet at the first time-slot in the inter-packet interval. In this way, the optical packet switch knows when to expect each new data packet from the source for routing to the destination.

### FIELD OF THE INVENTION

This invention is related to a method and system for routing data in an optical network between a source and a destination. More specifically, the invention relates to a novel approach for switching packets of data in the optical domain, i.e., without converting the packets to electronic format, that avoids packet collisions in the optical network yet retains the flexibility, robustness, and efficiency of packet switching.

### BACKGROUND

The transmission of data over optical networks today uses circuits in which one or more wavelengths or timeslots within a wavelength are dedicated to the sole use of a subscriber. This is referred to as Optical Circuit Switching (OCS). Over the past two decades, a debate over the relative merits of packet and circuit switching has ended in a resounding victory for packet switching as evidenced by the rapid and widespread acceptance of Internet Protocol (IP). Few people today question that networks in the near future will be based upon packet switching technologies and that IP will be the dominant protocol. Additionally, high speed optical transmission and Dense Wavelength Division Multiplexing (DWDM) technologies have greatly increased network capacities. The difficulty with such data rates lies in the extremely high cost of switching these tremendous streams of data using conventional electronic technologies.

Towards this end, current research efforts have focused on developing a method of packet switching for use on such DWDM optical networks, and optical cross connects (OXCs) have emerged as the preferred means to interconnect DWDM transmission systems. As with traditional TDM Digital Cross Connects (DCSs), OXCs are circuit switches that support long-lived circuits provisioned over long time frames of months to years. Optical cross connects often cannot switch less than a SONET STS-1 or OC-48 channel, i.e., less than 51.84 Megabits per second (Mbps) or 2.488 Gigabits per second (Gbps), respectively, and the time required to establish a connection is usually quite long, e.g., days, weeks, or months.

Many researchers have explored Optical Packet Switching (OPS) to extend the benefits of packet switching to the optical domain. Existing research in Optical Packet Switching usually applies the classic packet switching paradigm to optical networks, i.e., packets are sent “at will” (modulo traffic shaping and policing features) and the packet switches are designed to accommodate the stochastic arrival of packets. Researchers have demonstrated the feasibility of Optical Packet Switches that have switching times from nanoseconds to microseconds, and the question of the relative merits of optical packet and circuit switching has naturally arisen. It is not clear that the traditional benefits of packet switching—flexibility and greater utilization of resources due to statistical multiplexing—apply to optical networks.

Throughout this research a salient problem has been the lack of an effective technology to buffer optical packets. There is no equivalent to electronic Random Access Memory (RAM) packet buffers for optical packets, and finding a way to avoid the loss of packets due to collisions at switching points, or “contention resolution,” remains a key issue. One approach has been referred to as Optical Burst Switching. A principal feature of Optical Burst Switching is that data is transmitted before the virtual connection is established. This is done to avoid the round trip delay incurred during end-to-end acknowledgements in conventional connection establishment. Of course, the penalty paid is the increased probability of packet collision and loss, since the source client is not assured that sufficient resources are available to transmit the packets safely before sending the packets.

The inability to buffer packets in the optical domain poses a severe obstacle to the development of practical optical packet switches. To meet even a relaxed packet loss objective of 10⁻⁴, a bufferless optical packet switch must keep link utilization so low as to be grossly uneconomical. Researchers have explored alternatives to buffers such as delay lines, deflection routing, and transmission on multiple wavelengths, but these alternatives incur additional expenses such as multiple optical transmitters and receivers. These expenses may be so great that they exceed the cost benefits of packet switching, leaving optical cross connects the more economical and sensible solution.

Further, the benefit derived from statistical multiplexing may not be as significant in an optical network as in a conventional electronic packet network. Consider the approach of “multi-granular switching,” described in “Impact of Intermediate Traffic Grouping on the Dimensioning of Multi-Granularity Optical Networks,” by L. Noire and M. Vigourex (Optical Fiber Communications Conference, Anaheim, Calif. 2002). They showed a dramatic reduction in the number of wavelength ports needed in an optical network by switching at multiple granularities of bandwidth, as shown in FIG. 5. At the coarsest level of granularity, the contents of an entire fiber are switched using a fiber cross-connect 600. At the next level of granularity, the contents of a waveband, or a set of wavelengths, are switched as a unit at waveband cross-connect 610. The next finer level is a single wavelength cross-connect 620 and the finest level is a sub-wavelength on a Time Division Multiplexing (TDM) cross-connect 630 or on a packet switch 640. Packet switching makes more efficient use of bandwidth through statistical multiplexing, but in the scenario of multi-granular switching, optical packet switching optimizes a exceedingly small portion of the total traffic. The value derived from optical packet switching may be very small compared to the total cost of the system. A new paradigm is needed, and that is the approach taken in the Periodic Optical Packet Switching of the present invention.

Another optical switching technology is optical label switching as disclosed in U.S. Pat. No. 6,111,673. In optical label switching, the optical packet header is carried over the same wavelength as the packet payload data. Packet routing information is embedded in the same channel or wavelength as the data payload so that both the header and data payload propagate through network elements with the same path and the associated delays. The use of optical label switching depends on the ability to buffer packets in order to provide adequate contention resolution.

The ARPA sponsored All-Optical-Network (AON) Consortium resulted in an architecture that is a three-level hierarchy of sub-networks, and resembles that of LANs, MANs, and WANs seen in computer networks. The AON provides three basic services between Optical Terminals (OTs): A, B, and C services. A is a transparent circuit-switched service, B is a transparent time-scheduled TDM/WDM service, and C is a non-transparent datagram service used for signaling. The B service uses a structure where a 250 microsecond frame is used with 128 slots per frame. Within a slot or group of slots, a user is free to choose the modulation rate and format. The separation of Network Control and Management (NC&M) signaling in the C-service with the payload in the B-service requires careful synchronization between the signaling header and the payload. This requirement becomes far more stringent as the 250 microsecond frame is used with 128 slots per frame with arbitrary bit rates. Not only does the synchronization have to occur at the bit level, this synchronization has to be achieved across the entire network. The scalability and interoperability are extremely difficult since these do not go in steps with the network synchronization requirement.

It would be desirable to have a system and method that could provide flexible optical transmission service, guaranteeing throughput of virtually any size and enabling an increase or decrease in the size of the data being sent easily and without service disruption.

Further it would be desirable to have a system and method to implement a robust optical transmission service where packets can be rerouted to recover from failed network components or for network reconfiguration.

Additionally, it would be desirable to have a system and method that achieves a high-utilization of the available bandwidth by avoiding problems caused by packet collisions.

Also, it would be desirable to have a system and method capable of routing packets of data without the use of packet buffers.

### SUMMARY

In accordance with the present invention, a method and system for switching packets of optical data in an optical network provides for a network management system that allocates a connection between a source and a destination via a fixed pathway of optical fiber through a fixed route of optical packet switches. Each wavelength is divided into a plurality of time slots. The network allocates a set number of time slots as an inter-packet interval for the transmission of data packets from the source to the destination. The source may only transmit packets of data at the start of an inter-packet interval.

The proposed solution to contention resolution problems in optical packet switching is analogous but not identical to the existing data services Frame Relay Service (FRS) with Committed Information Rate (CIR) and Asynchronous Transfer Mode (ATM) with Constant Bit Rate (CBR). Both FRS CIR and ATM CBR are packet-based connection-oriented services with guaranteed throughput in which a subscriber may establish a connection by a “call request” negotiation with the network. In the present invention these types of data services have been modified with a form of traffic shaping in which the client can send packets only at specified intervals. It is as if these services are transported through the network by time slot interchange circuit switches.

Periodic optical packet switching (“POPS”) is based upon three key features. First, periodic optical packet switching is a connection-oriented scheme in which a source client establishes a connection to a destination client via a conventional “call request” and in which a connection traverses a fixed route of optical packet switches (OPSs). Second, the POPS network is “slotted” in that the bandwidth of the wavelengths is divided into fixed length time slots and all devices in the POPS network, both clients and switches, are synchronized to a common clock. Third, the source client may transmit an optical packet only at specified “inter-packet intervals,” which are time intervals that are multiples of the time-slot.

The structure of a POPS packet is analogous to a freight train. Just as a locomotive is followed by several freight cars filled with cargo, the header of a POPS packet is followed by several time slots filled with data. Further, just as freight trains can have different lengths that are multiples of the length of a freight car, POPS packets can have different lengths that are multiples of the length of a time slot. To extend the analogy, consider a coal mine at which freight trains are continuously filled and sent on their way. To prevent congestion in the railway, the coal mine is permitted to send a train only at specific time intervals, e.g., at exactly 1:00 PM on each day. Also, the coal mine is permitted to send a freight train with no more than 200 freight cars; it may send fewer than 200, but it cannot send more. The “inter-train interval” is 24 hours, and trains have variable lengths that are multiples of the length of a freight car up to a maximum length of 201 cars (counting the locomotive as a car). Similarly, a POPS source client can transmit a POPS packet once every “inter-packet interval,” and the packet can have variable lengths that are multiple of the length of a time slot up to a maximum length, or “max_packet_length.”

A POPS network eliminates packet collisions by: i) scheduling the transmission of packets so they arrive at known times at each POPS switch traversed in the path from source to destination; and ii) dedicating resources at each switch so packets can be switched without collision. Using the knowledge of the packet arrival times and durations, the POPS switches execute a scheduled sequence of configurations to route each packet from its input port to the appropriate output port without collision.

The POPS network is required to do the following. The network must maintain a database of all of the existing connections and allocated resources in the network and use this information to calculate a route for a new connection that is free from contention, i.e., no other connection will transmit packets that will collide at the traversed optical packet switches. The network must inform the traversed optical packet switches of the parameters of the connection, e.g., the input and output wavelengths and the maximum length and arrival time of the optical packets. The network must inform the source client of the starting time at which the client may begin to transmit packets and the time interval between packet transmission, or connection_start_time and connection_inter_packet_interval, respectively. As mentioned earlier, the source client observes a stringent form of traffic shaping in which it may transmit a packet only at the beginning of its allocated time interval.

The source client and traversed OPS switches are assured that there will be no packet collisions in the current connection for the following reasons:

1. the network will not permit any other connection to use an identical time slot at any OPS switch traversed by the current connection,

2. the source client transmits an optical packet only at the specified intervals;

3. the traversed OPSs “know” when to expect the optical packets so they can switch the packets successfully.

The POPS service is flexible because the throughput guarantee can be of virtually any size and can be increased or decreased in a straightforward way without service disruption. Further, the throughput of the service can exceed the capacity of a single wavelength because wavelengths can be bundled and treated as an aggregate link. The POPS service is robust because the optical packets can be rerouted for network reconfiguration or to recover from failed network components. Another benefit is that the packets can be protected by a checksum that can provide performance monitoring of the optical signal as well as error detection in packets.

### BRIEF DESCRIPTION OF THE DRAWINGS

FIG. 1 depicts an embodiment of a network for use with the periodic optical packet switching in accordance with the present invention;

FIG. 2 depicts the relationship of slotted bandwidths and packet intervals;

FIG. 3 depicts an optical to electrical switch in accordance with the prior art;

FIG. 4 is a flow diagram depicting the flow of data in a source request in accordance with the present invention.

FIG. 5 depicts the concept of optical switching at multiple levels of granularity.

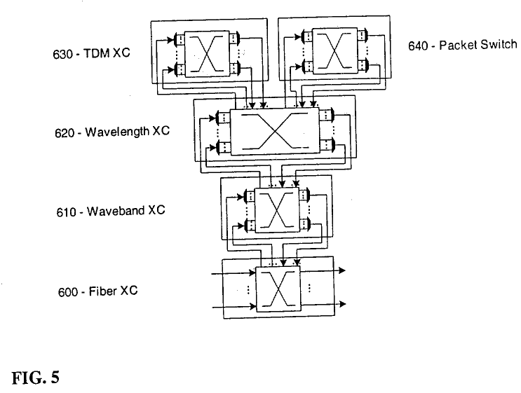

### DETAILED DESCRIPTION

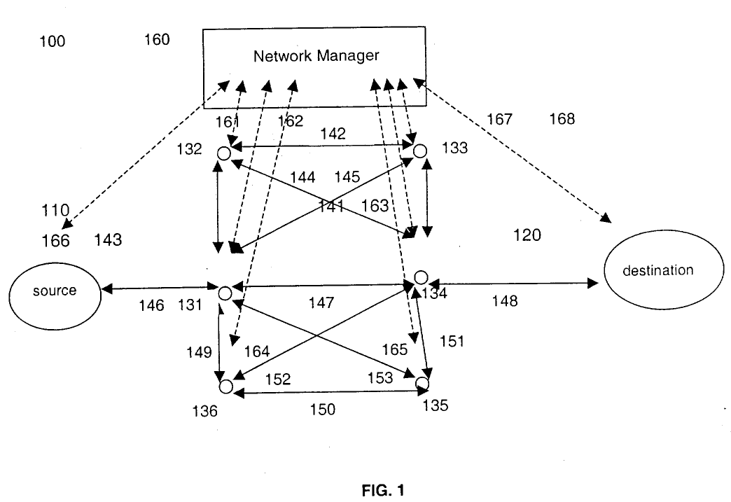

FIG. 1 depicts an optical network 100 in accordance with the present invention. Packets of data are transmitted between source 110 and destination 120 via a plurality of optical packet switches 131-136 over optical fibers 141-153. Each optical fiber is capable of carrying a plurality of different wavelengths of light in a Wavelength Division Multiplexed (WDM) format. Each wavelength is divided into a plurality of time slots. Upon receipt of a connection establishment request from source 110, a network manager or network management system (NMS) 160 allocates specific bandwidth to the connection. The NMS must specify a pathway between source 110 and destination 120 for the transmission of data from the source 110 to the destination 120. For example, the NMS 160 may decide that the best path at a given time is from optical packet switch 131 over optical fiber 141 to optical packet switch 132 continuing over optical fiber 142 to optical packet switch 133 over optical fiber 143 to optical packet switch 134 connected to destination 120 over optical fiber 148.

The NMS 160 also assigns to the transmission a wavelength from the plurality of wavelengths the system is capable of transmitting in each optical fiber in the path. The NMS 160 must provide each optical packet switch in the chosen pathway with the input and output wavelengths to be used for the transmission for a given connection.

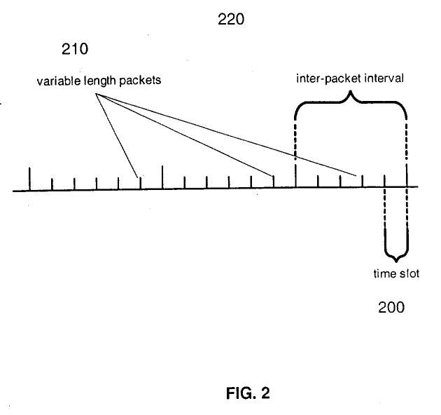

Each wavelength of light is “slotted” into a plurality of time slots 200 as depicted in FIG. 2. A time slot (or time_slot) 200 is the minimum amount of time that can be allocated by the NMS 160 and is closely related to the minimum packet length divided by the wavelength bandwidth. Whether the duration of the time slot is measured in nanoseconds, microseconds, or milliseconds is function of system parameters such as switch configuration time. Wavelength bandwidth is the number of bits per second a specific wavelength is capable of transmitting. The minimum packet length is a parameter set by design of the system to be the minimum length in bits for all packets for all transmission connections in the system.

The POPS minimum length packet and the Optical Circuit Switching (OCS) time slot are similar in that they are each the minimum quantity of bandwidth that can be allocated or switched by the network. For example, the minimum unit of bandwidth that can be switched in some existing Optical Cross-Connects (OXCs) is an STS-1 (51.84 Mbps or an OC-48 (2.488 Gbps), as mentioned earlier,. The minimum unit of bandwidth that can be switched in a POPS network is determined by the minimum length optical packet. Many factors influence the size of the minimum packet length, e.g., the time required to configure a POPS switch and the time needed by a POPS switch to read and process an optical packet header. In POPS, then, the minimum bandwidth and the granularity of allocation can be expressed in equation (1).

$$\begin{matrix}= channel bandwidth \times \frac{min\_packet \_length / channel bandwidth}{max\_inter \_packet \_interval} \\ = \frac{min\_packet \_length}{max\_inter \_packet \_interval}\end{matrix} \qquad ( 1 )$$

A significant difference between POPS and Optical Circuit Switching is that the POPS network does not operate within a fixed and repeating “master” transmission cycle as in telephony networks. For example a SONET network is based upon the fundamental cycle, or transmission frame, of 125 μsec. The absence of a repeating transmission cycle in POPS enables greater flexibility in bandwidth allocation because the network is freed from the constraints imposed by the repeated cycle. In a network with time slots and a fixed cycle, the minimum bandwidth and the granularity of allocation is expressed as equation (2).

$$channel bandwidth \times \frac{time slot duration}{cycle duration} \qquad ( 2 )$$

For example, consider a 1 Mbps transmission channel with a 1 μsec time slot and a 1 msec cycle. The minimum bandwidth allocation is determined using equation (2) as in equation (3).

$$minimum bandwidth = 1 Mbps \times \frac{1 µsec}{1 m sec} = 1 Kbps \qquad ( 3 )$$

In POPS, however, the granularity of bandwidth allocation is no longer a function of a cycle, and the bandwidth allocation can be made arbitrarily small by making the connection inter-packet interval (connection_inter_packet_interval) 210 arbitrarily large. The maximum bandwidth, of course, is the capacity of the entire wavelength or of multiple wavelengths in aggregate link capability. There are, however, benefits that would be lost if the connection_inter_packet_interval is unbounded. For example, the network may decide that a connection has failed if no data is received within a “timeout” interval, and this could not be done if the connection_inter_packet_interval is virtually infinite. Also, a maximum inter_packet_interval may simplify the algorithm used to determine the availability of resources to serve a new connection. Therefore, POPS includes a max_inter_packet_interval, but the value of this system parameter is very much larger than values usually considered for a cycle. POPS distinguishes between the maximum inter-packet interval and the connection inter-packet interval by using the parameter names max_inter_packet_interval and connection_inter_packet_interval for each respectively.

Thus, for a given transmission, the NMS 160 must also set the connection_inter_packet_interval 210. The connection_inter_packet_interval 210 is the time interval between new packet transmissions for a specific connection measured in time-slots. The inter-packet interval may be any number of time slots up to the maximum inter-packet interval, or max_inter_packet_interval. For example, for a given transmission between source 110 and destinations 120 the inter packet interval 210 could be that shown in FIG. 2 where it is equal to five time-slots. The source 110 may now only send packets of data starting at the first time slot in each inter-packet interval 210. The POPS network 100 is capable of switching any variable length optical packet within a minimum and a maximum length, and FIG. 2 shows three packets 220 of data being sent. Each packet 220 may be of variable length. Packets 220 having the lengths of four time slots, two time slot and three time slots are depicted as being transmitted in FIG. 2. A POPS packet may occupy one or more time slots up to a maximum length, but the beginning of each packet occurs only at the beginning of each connection inter-packet-interval.

As with TDM circuits and virtual circuits, the source and destination clients (A and Z points) are fixed upon connection establishment and do not vary during the duration of the service. Adequate network resources are dedicated in a POPS network during connection establishment to guarantee the throughput of the connection, and the service request of the source node 110 needs to include an estimation of the bandwidth required by the source to destination 120. Without an adequate idea of the required bandwidth the NMS 160 either will not allocate sufficient bandwidth thereby resulting in delays or it will allocate too much bandwidth for too little data, thereby reducing the effective utilization of the network. It is important that the source 110 provides the NMS 160 with a good estimation of the required bandwidth but it is not critical. One of the exemplary features of the POPS network is the ability of the network to adjust the allocated connection parameters to maximize efficiency. POPS does support dynamic throughput, i.e., the ability to increase or decrease the bandwidth allocated to the connection “on the fly.” If the source 110 experiences excessive delay in its data buffer then it may request greater bandwidth from the NMS 160 which can then easily modify the allocated bandwidth by modifying the inter-packet interval and connection_max_packet_length. If the source 110 or the NMS 160 determines that the connection is underutilized the NMS could make immediate modifications to the same parameters thereby freeing network capacity for other users.

The NMS 160 must inform the source client of the starting time at which the client may begin to transmit packets and the time interval between packet transmission, or connection_start_time and connection_inter_packet_interval, respectively.

The NMS 160 must inform the traversed optical packet switches of the parameters of the connection, e.g., the input and output wavelengths and the expected length and arrival time of the optical packets. At each optical packet switch 131-136 a table must be maintained that contains the information necessary to switch the data packets onto the proper optical fiber and wavelength toward the next optical packet switch in the allocated connection pathway to the destination. The input port and wavelength of the data packets must be known as well as the output port and wavelength. Each optical packet switch knows that a packet of data will start to arrive in the first time slot in the connection_inter_packet_interval at the specified input port and wavelength. The switch must then route the packet of data to the specified output port and wavelength.

As with many high capacity circuit switched services, a POPS connection is typically long-lived. The service is not meant for brief data transfers, as between a client browser and a network server, but is better suited to long term connectivity between subscriber endpoints or between high capacity electronic packet switches such as EtherSwitches or IP routers. The reason that POPS is not appropriate for brief data transfers is that the time required to establish a connection, i.e., to receive a request from a source 110, to allocate the pathway, to communicate the allocation to the appropriate optical packet switches, and to inform the source and destination clients, may exeed the time spent actually transmitting data. The overhead in setting up the connection would quickly negate the benefit of POPS for brief data transmissions.

The NMS 160 communicates with each source 110, destination, 120 and optical packet switch 131-136 either through in-band communication or through a separate communication network depicted as communication lines 161-168 in FIG. 1. In either case, the NMS 160 sends connection information such as the source, destination, maximum packet length, and inter-packet interval to the various optical packet switches to route the data packets.

Packet size is limited by a desire to bound the requirements on network elements and hosts. However, POPS distinguishes between the network maximum packet length and a connection maximum packet length, as is done with the inter_packet_interval. The motivation for this distinction is to increase the flexibility of the network. If the connection_max_packet_length always equals the network_max_packet_length, then the POPS network must be prepared at all times to switch a maximum length packet for every connection. The granularity of bandwidth allocation therefore becomes much coarser because the time slot allocated to connections must always be the transmission time of a maximum length packet rather than a minimum length packet, as stated in our earlier discussion. By creating a connection_max_packet_length that may be less than or equal to the network_max_packet_length, we retain the benefits of a maximum packet length as well as the flexibility of a finer granularity in bandwidth allocation.

Effectively, POPS uses three parameters to control the bandwidth allocated to a specific transmission connection:

1) min_packet_length

2) connection_inter_packet_interval

3) connection_max_packet_length

The bandwidth allocated to a connection may be expressed by equation (4)

$$\frac{connection\_max \_packet \_length}{connection\_inter \_packet \_interval} \qquad ( 4 )$$

Although the POPS network is slotted and source clients are required to send packets only at the beginning of the connection_inter_packet_interval, the POPS network has the flexibility to shift the inter-packet interval either forward or backward in time. This relaxation provides several benefits. For example, a new connection may be blocked in a highly utilized network because there are insufficient time slots to provide the bandwidth requested. The NMS can make use of the flexibility in the timing of the connection inter-packet interval to “shift” the packet arrival times of existing connections and “make room” for new connection. Another benefit is the ability for the network to reconfigure the connections in a network into a more efficient arrangement, that is, to “defragment” the bandwidth in an operation analogous to hard disk defragmentation. In defragmentation, the connection parameters allocated to a plurality of connections are reallocated to as to consolidate non-contiguous blocks of unallocated time-slots (unused bandwidth) for later allocation.

Timing in a POPS network is an important consideration and there are several timing parameters that must be uniform across all of the elements in the network, e.g., connection_inter_packet_interval, max_inter_packet_interval, time_slot, and guard_band. The guard band is “dead time” at the beginning and end of a time-slot to accommodate variations in equipment performance. The guard band is a network parameter set by the NMS 160 and communicated to all network elements. The most critical of the timing parameters is time_slot, which is the basis for bandwidth allocation and switching. Because it is impractical to have absolute synchronization across all of the switches in the network, it is inevitable that the time slots on different input wavelengths will not arrive at precisely the same time and that the duration of the time slots will not be precisely identical. This creates impairments that must be overcome, i.e., time slot misalignment and time slot “slips and adds.” However, time slot alignment is a problem that has been thoroughly researched, and there are several techniques available to address the issue.

The utilization and cost effectiveness of a POPS network can be very high because packet collisions are avoided by scheduling and demand can be “packed” into the network. Another benefit is related to network design. A principal metric in the design of transport networks is the “cost per bit,” and a general guideline is to use network elements with the largest capacity and the greatest economies of scale whenever possible. However, large capacity network elements can seldom switch at fine granularity; for example, some OXCs cannot switch less than an OC-48 (2.488 Gbps). In contrast, a POPS switch can switch with both coarse and fine granularity. Tables 1 and 2 below show the relationships between the wavelength bandwidth, the minimum packet length (or minimum switching time) and switching granularity (in bps), assuming that max_inter_packet_interval is 1 second in Table 1 and 50 milliseconds in Table 2.

TABLE 1

| Wave- | | | | | | |
|---|---|---|---|---|---|---|
| length | | | | | | |
| Band- | Minimum Packet Length (in time) | | | | | |
| width | 100 ms | 1 ms | 10 μs | 1 μs | 10 ns | 1 ns |
| OC-1 | 5,184,000 | 51,840 | 518 | 52 | 1 | 0 |
| OC-3 | 15,552,000 | 155,520 | 1,555 | 156 | 2 | 0 |
| OC-12 | 62,208,000 | 622,080 | 6,221 | 622 | 6 | 1 |
| OC-48 | 248,832,000 | 2,488,320 | 24,883 | 2,488 | 25 | 2 |
| OC-192 | 995,328,000 | 9,953,280 | 99,533 | 9,953 | 100 | 10 |
| OC-768 | 3,981,312,000 | 39,813,120 | 398,131 | 39,813 | 398 | 40 |

TABLE 2

| | Minimum Packet Length (in time) | | | | | |
|---|---|---|---|---|---|---|
| Wavelength Bandwidth | 100 ms | 1 ms | 10 μs | 1 μs | 10 ns | 1 ns |
| OC-1 | 51,840,000 | 1,036,800 | 10,368 | 1,037 | 10 | 1 |
| OC-3 | 155,520,000 | 3,110,400 | 31,104 | 3,110 | 31 | 3 |
| OC-12 | 622,080,000 | 12,441,600 | 124,416 | 12,442 | 124 | 12 |
| OC-48 | 2,488,320,000 | 49,766,400 | 497,664 | 49,766 | 498 | 50 |
| OC-192 | 9,953,280,000 | 199,065,600 | 1,990,656 | 199,066 | 1,991 | 199 |
| OC-768 | 39,813,120,000 | 796,262,400 | 7,962,624 | 796,262 | 7,963 | 796 |

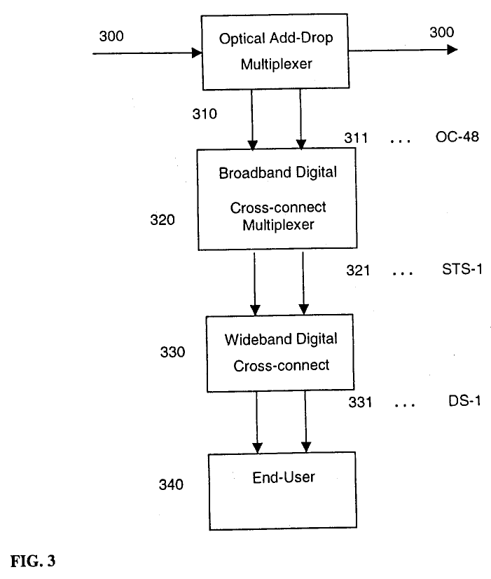

Even at a rate as high as OC-768 with 10 μsec switching time, the POPS switch can switch a connection with bandwidth of only 400 Kbps and 8 Mbps when max_inter_packet_interval=1 second and 50 msec, respectively. The ability to switch both extremely large and small bandwidth connections is significant because a single POPS switch can do what is currently done by two or more network elements. For example, FIG. 3 below depicts a configuration in which an Optical Add-Drop Multiplexer (OADM) 310 drops an OC-48 wavelength within WDM fiber 300 through lines 311 to a Broadband Digital Cross-connect (BDCS) 320. The BCDS 320 in turn demultiplexes an STS-1 signal and hands it through lines 321 to a Wideband Digital Cross-connect (WDCS) 330, which finally demultiplexes a DS1 signal through lines 331 for an end-user 340. All of these distinct network elements could potentially be consolidated into a single POPS switch with considerable savings for the network service provider. Of course, electronics would have to be added to the POPS switch to convert the optical signal to DS1 electronic format or to the appropriate format for the subscriber.

POPS may also be used to provide multicasting in that the optical packet switches can switch the data coming into an input port onto multiple output ports to delivery to multiple destinations.

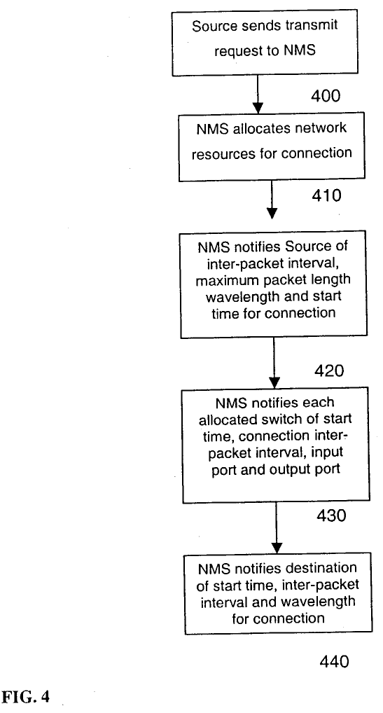

The method of present invention for setting up a specific connection is depicted in the flow diagram in FIG. 4. Prior to setting up a specific connection, certain network parameters have already been determined, i.e., the max_packet_length, max_inter_packet_interval, minimum_packet_length, guard_band and time_slot. To set up a connection, at step 400 the source 110 sends a request to transmit data to the NMS 160. The request to transmit data includes the identity of the destination and the estimation of the necessary bandwidth. At step 410 the NMS 160 executes an allocation algorithm to determine the parameters of the connection. Connection parameters that are determined by the NMS 160 include the physical pathway or circuit to be traversed by the data, i.e., the fiber, wavelength and optical packet switches through which the data will be routed. The NMS 160 also determines the connection inter-packet interval (connection_inter_packet_interval) in time-slots, the connection maximum packet length (connection_max_packet_length) in bits and the connection start time. Once the NMS 160 has performed the allocation step it must send information about the connection—the wavelength, connection inter-packet interval, connection maximum packet length and start time to source 120 at step 420. At step 430, the NMS 160 forwards the information needed by each optical packet switch, i.e., the connection start time, connection inter-packet interval, input port and output port for the connection so that an optical packet switch through which the data is traveling will know when to expect data, where to expect the data and where to route the data. At step 440, the NMS 160 notifies the destination of the connection start time, connection inter-packet interval and wavelength on which it can expect the data packets. At this point source 110 may now begin transmitting packets of data up to the connection maximum packet length at the start time or at the beginning of any connection inter-packet interval thereafter. Each optical packet switch in the allocated pathway will now be able to switch the packets of data that it receives at the known time (based on the connection start time and inter-packet interval) on the input port to the proper output port. The destination 120 will receive the variable-length packets of data at the beginning of one or more of the inter-packet intervals for the allocated wavelength.

The above description has been presented only to illustrate and describe the invention. It is not intended to be exhaustive or to limit the invention to any precise form disclosed. Many modifications and variations are possible in light of the above teaching. The applications described were chosen and described in order to best explain the principles of the invention and its practical application to enable others skilled in the art to best utilize the invention on various applications and with various modifications as are suited to the particular use contemplated.

I claim:

1. In an optical fiber network for transmitting packets of data between a source and a destination at one or more optical wavelengths through a plurality of optical packet switches, a method of establishing a connection for transmission comprising the steps of:
receiving a connection request from the source at a network management system;
allocating at the network management system a set of connection parameters comprising an optical fiber pathway, a wavelength, a start time, a connection inter-packet interval and a connection maximum packet length for the connection;
notifying the source of the allocated wavelength, start time, connection inter-packet interval and connection maximum packet length;
notifying each optical packet switch along the optical fiber pathway of the start time, connection inter-packet interval and input port at which to expect packets of data and the output port to which the packets of data should be switched for transmission to the destination; and
notifying the destination of the wavelength, start time and connection inter-packet interval for the connection.

2. The method of claim 1 wherein the step of allocating further comprises the step of dividing the wavelength into a plurality of equal length time-slots and wherein the connection inter-packet interval is a plurality of time-slots.

3. The method of claim 1 wherein the connection inter-packet interval is less than or equivalent to the maximum inter-packet interval for the network.

4. The method of claim 1 wherein the step of notifying the source is accomplished through a direct communication between the network management system and the source.

5. The method of claim 1 wherein the step of notifying the optical packet switches is accomplished through a direct communication between the network management system and each optical packet switch in the pathway.

6. The method of claim 1 wherein the step of notifying the destination is accomplished through a direct communication between the network management system and the destination.

7. The method of claim 1 wherein the steps of notifying the source, the optical packets switches in the allocated pathway and the destination are accomplished through either in-band or out-of-band communication.

8. The method of claims 1 where in the connection request transmitted from the source to the network management system includes an indication of the estimated bandwidth required for the connection.

9. In an optical fiber network for transmitting packets of data between a source and a destination on one or more optical wavelengths through a plurality of optical packet switches, a method of transmission comprising the steps of:
transmitting a connection request from the source to a network management system;
allocating at the network management system a set of connection parameters comprising an optical fiber pathway, a wavelength divided into a plurality of equal length time-slots, a connection start time, a connection inter-packet interval equivalent to a plurality of time-slots, and a connection maximum packet length for the connection;
notifying the source of the allocated wavelength, connection start time, connection inter-packet interval and connection maximum packet length;
notifying each optical packet switch along the optical fiber pathway of the connection start time, connection inter-packet interval and input port at which to expect packets of data and the output port to which the packets of data should be switched for transmission to the destination;
notifying the destination of the wavelength, connection start time and connection inter-packet interval for the connection; and,
transmitting packets of data from the source to the destination through the optical packets switches in the allocated pathway at the connection start time or at the start of any connection inter-packet interval thereafter.

10. The method of claim 9 wherein the packets of data transmitted by the source to the destination are of a length less than the connection maximum packet length.

11. The method of claim 9 wherein the step of allocating further comprises determining that the connection parameters of wavelength, optical fiber pathway, connection start time connection maximum packet length and connection inter-packet interval do not conflict with any other connection parameters allocated to any other connection.

12. The method of claim 9 wherein the step of allocating further comprises determining a guard band during which time period data is not transmitted.

13. A network management system for the allocation of connection parameters for transmission of packets of data in a multiple wavelength optical fiber network from a source through one or more optical packet switches to a destination comprising:
means for dividing each wavelength into a plurality of equal length time-slots;
means for allocating, in response to each transmission request from a source, a set of connection parameters comprising a pathway through a plurality of optical packet switches, a wavelength, a start time, a connection inter-packet interval and a connection maximum packet length; and,
means for maintaining a database of all connection parameters allocated to all connections in the network so as to permit the allocation means to determine if there are any conflicts with the connection parameters allocated to any other connection.

14. The network management system of claim 13 wherein the connection inter-packet interval is less than the maximum inter-packet interval for the network.

15. The network management system of claim 13 further comprising a means for setting a minimum packet length based on the speed at which the optical packet switches can switch data.

16. The network management system of claim 13 further comprising means for communicating certain communication parameters to each of the source, the destination, and each of the optical packet switches in the allocated pathway.

17. The network management system of claim 16 wherein the allocated wavelength, start time, maximum inter-packet interval and maximum packet length are communicated to the source requesting the connection.

18. The network management system of claim 16 wherein the input port, output port, start time and inter-packet interval are communicated to each of the optical packet switches in the allocated pathway between the source and the destination.

19. The network management system of claim 16 wherein the wavelength, start time and inter-packet interval are communicated to the destination.

20. The network management system of claim 14 wherein the means for allocating further comprises a means for bundling the time slots available over a plurality of wavelengths or fibers if the bandwidth requested by the source exceeds the capacity of any one wavelength or fiber.

21. The network management system of claim 14 further comprising a means for determining if there is a failure of a network component and for requesting reallocation of all of the affected connections.

22. The network management system of claim 14 further comprising a means for defragmenting the allocated time slots for a given wavelength by changing the connection parameters for a plurality of connections so as to consolidate non-contiguous unallocated time-slots.

23. The network management system of claim 14 wherein the set of connection parameters further includes a guard band.

24. In an optical fiber network for transmitting packets of data from a source to a destination over optical fibers connected by a plurality of optical packet switches, a method of source transmission comprising the steps of:
sending to a network management system a request to transmit data requiring an estimated amount of bandwidth over time;
receiving an allocated wavelength, start time, inter-packet interval and maximum packet length for the connection;
transmitting one or more packets of data at the start time or any inter-packet interval thereafter.
